(19) United States
(12) Patent Application Publication
(10) Pub. No.: US 2015/0002422 A1
(43) Pub. Date: Jan. 1, 2015

(54) ELECTRONIC DEVICE AND METHOD OF CONTROLLING THE SAME

(71) Applicant: Acer Incorporated, New Taipei City (TW)

(72) Inventors: Chi-Jen Chen, New Taipei City (TW); Shau-Yang Hsieh, New Taipei City (TW); Tzu-Ching Lin, New Taipei City (TW); Chih-Feng Hsu, New Taipei City (TW); Shih-Yang Wang, New Taipei City (TW); Jen-Hao Cheng, New Taipei City (TW); Kuang-Rong Lu, New Taipei City (TW)

(21) Appl. No.: 14/312,937

(22) Filed: Jun. 24, 2014

(30) Foreign Application Priority Data
Jun. 26, 2013 (TW) 102122645

(51) Int. Cl. G06F 3/041; G06F 3/0488

(52) U.S. Cl. CPC G06F 3/0416; G06F 3/0488
USPC 345/173

(57) ABSTRACT

An electronic device and a method of controlling the same are provided. The electronic device includes a touch screen and a controller. The controller detects a trigger signal while the electronic device is in a user-interface lock state. When the trigger signal is detected, the controller executes a touch-gesture recording program, and receives and stores an input touch-gesture.

### CROSS REFERENCE TO RELATED APPLICATIONS

This application claims priority of Taiwan Patent Application Ser. No. 102122645, filed Jun. 26, 2013 entitled ELECTRONIC DEVICE AND METHOD OF CONTROLLING THE SAME. The contents of this application are hereby incorporated by reference.

### BACKGROUND OF THE INVENTION

1. Field of the Invention

The disclosure relates generally to electronic devices and a method of controlling the same and, more particularly, to receiving and storing touch-gesture input through a touch screen under a user-interface lock state.

2. Description of the Related Art

Recently, electronic devices, such as portable devices, have become more and more technically advanced and multifunctional. Due to increased convenience and functions of the devices, these devices have become necessities of life. Using such electronic devices, users can make phone calls, as well as conduct social interactions and business transactions. As a result, the importance and variety of log files and personal data stored in these portable devices have increased.

Users may interact with the portable device through a touch screen. In order to protect these log files and personal data stored in the portable device, such a portable device locks the touch screen after a certain period of idleness. A user is required to perform a certain action (for example, to perform a certain gesture using the device's touch screen) to unlock the device in order to access the device.

A portable device under the user-interface lock state protects the log files and personal data stored therein, and limits access to a user who cannot perform the required unlock action (hereinafter referred to as a non-owner).

In our daily life, sometimes we leave a message to someone using a post-it note or a small piece of paper. It would be convenient and paper-saving if we can leave an electronic note on a tablet or laptop computer.

Accordingly, there is a need for an electronic device, which allows a user (a non-owner of the electronic device) to leave a message (to the owner of the electronic device) on the touch screen of the electronic device and limits the non-owner's access data stored in the electronic device (such as log files and personal data).

### BRIEF SUMMARY OF THE INVENTION

A method of controlling an electronic device with a touch-sensitive screen and an electronic device are provided.

In an embodiment of a method of controlling an electronic device with a touch-sensitive screen, the electronic device operates in a user-interface lock state. While the electronic device is in the user-interface lock state, a starting signal is detected, and a touch-gesture recording process is executed in response to the starting signal. A touch-gesture on the touch screen is received and stored.

An embodiment of an electronic device includes a touch-sensitive screen and a controller. The touch-sensitive screen comprises a display and receives touch inputs (such as touch-gestures). While the electronic device is in a user-interface lock state, the controller detects a starting signal, and in response to the starting signal, executes a touch-gesture recording process, and receives and stores a touch-gesture on the touch screen.

Methods of controlling an electronic device with a touch-sensitive screen, and related operating systems may take the form of a program code embodied in a tangible media. When the program code is loaded into and executed by a machine, the machine becomes a device for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electronic device of the invention;

FIG. 2 is a flowchart of an embodiment of a method of leaving an electronic message in an electronic device via a touch-sensitive screen;

FIGS. 3A˜3D illustrate displays of an electronic device according to embodiments of the invention;

FIG. 4 is a flowchart of an embodiment of a method of reading an electronic message stored in an electronic device;

FIGS. 5A˜5B illustrate displays of an electronic device according to embodiments of the invention.

### DETAILED DESCRIPTION OF THE INVENTION

Methods of controlling an electronic device with a touch-sensitive screen and electronic device are provided.

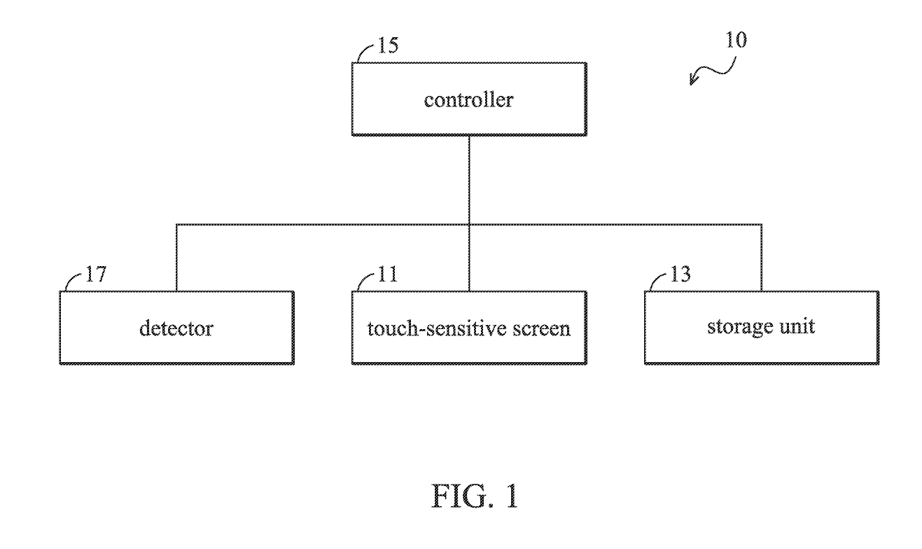

FIG. 1 is a schematic diagram illustrating an embodiment of an electronic device of the invention. According to an embodiment, an electronic device 10 can be a personal computer or portable electronic device, such as a PDA (Personal Digital Assistant), a mobile phone, a smart phone, or a mobile Internet Device (MID).

The electronic device 10 comprises a touch-sensitive screen 11, a storage unit 13, a controller 15, and a detector 17.

The touch-sensitive screen 11 has a touch-sensitive surface. The touch-sensitive screen 11 can detect contact and movement of a control tool, such as a stylus or finger(s) on the touch-sensitive surface. The touch-sensitive screen 11 can display related graphics, data, and interfaces. The touch-sensitive screen 11 receives input corresponding to user manipulation, and transmits the received input to the controller 15 for further processing.

The storage unit 13 stores personal data, settings and software of the electronic device 10. The personal data can be various user data or personal files such as an address book, call list, received/sent messages, and internet cookies.

The controller 15 executes a method of controlling an electronic device with a touch-sensitive screen of the invention. Related details are discussed below.

The detector 17 detects a pre-defined starting signal. For example, the starting signal is generated in response to one of the following events: pulling out a stylus, activating a virtual button, or pressing a physical button. The detector 17 can be omitted when the starting signal is generated in response to activating a virtual button. In this case, the detection function performed by the detector 17 can be implemented by the touch-sensitive screen 11.

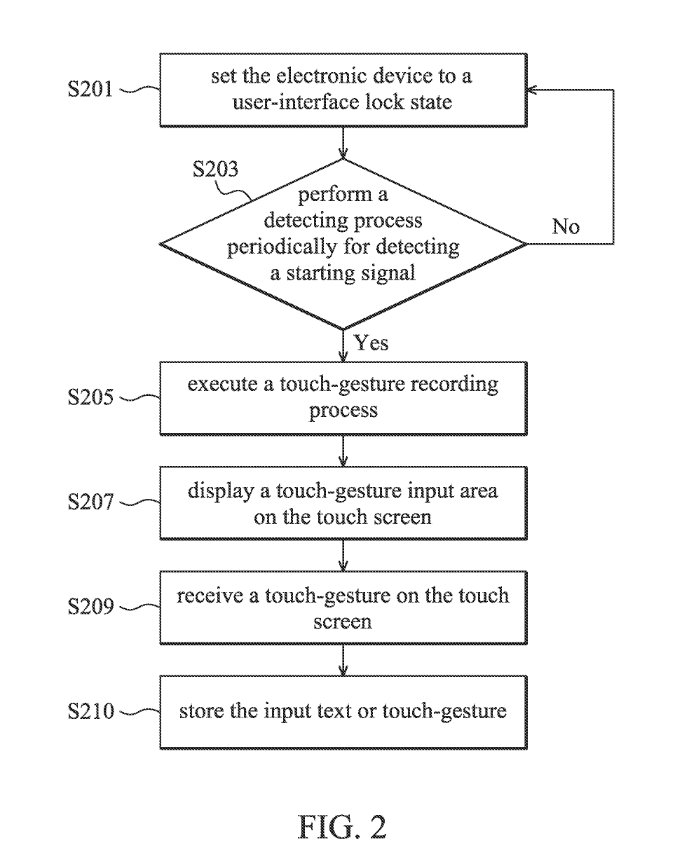

FIG. 2 is a flowchart of an embodiment of a method of leaving an electronic message in an electronic device via a touch-sensitive screen. The method of leaving an electronic message in an electronic device via a touch-sensitive screen can be used in an electronic device, including but not limited to a PDA (Personal Digital Assistant), a smart phone, a mobile phone, or the like. According to an embodiment, the electronic device is equipped with a touch-sensitive screen.

All of the steps illustrated in FIG. 2 are performed by a user other than the owner of the electronic device while the electronic device is in the user-interface lock state. In this specification, for simplicity, “a user other than the owner of the electronic device” is referred to as a “message maker”, who is not an owner of the electronic device and does not have the authority to unlock the electronic device. In addition, the user who has the authority to unlock the electronic device is referred to as an “owner of the electronic device”, who can unlock the electronic device and access full functionality of the electronic device.

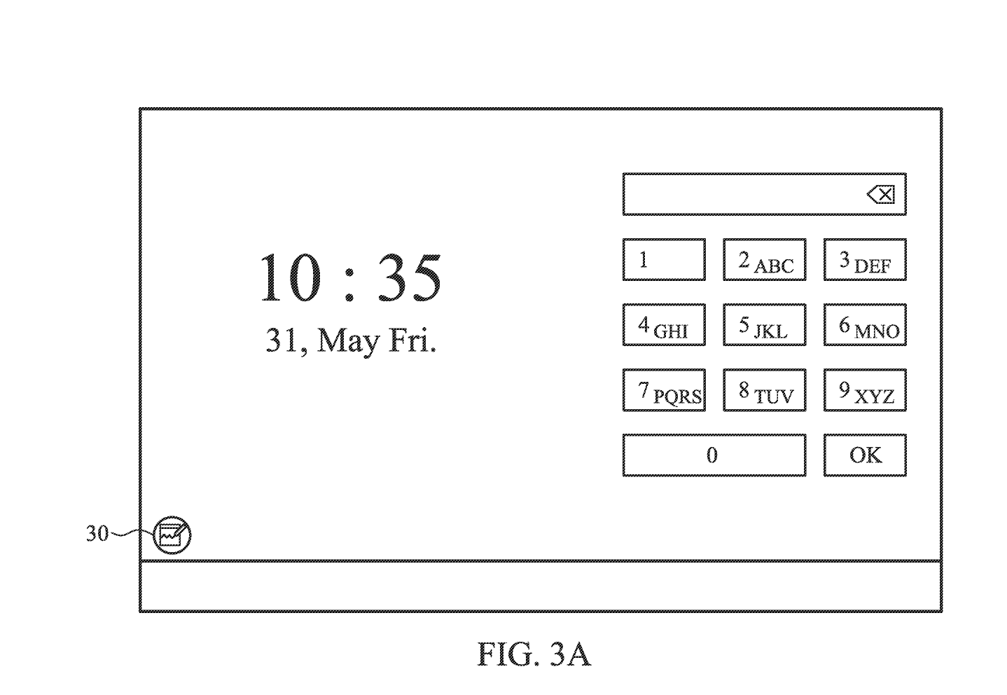

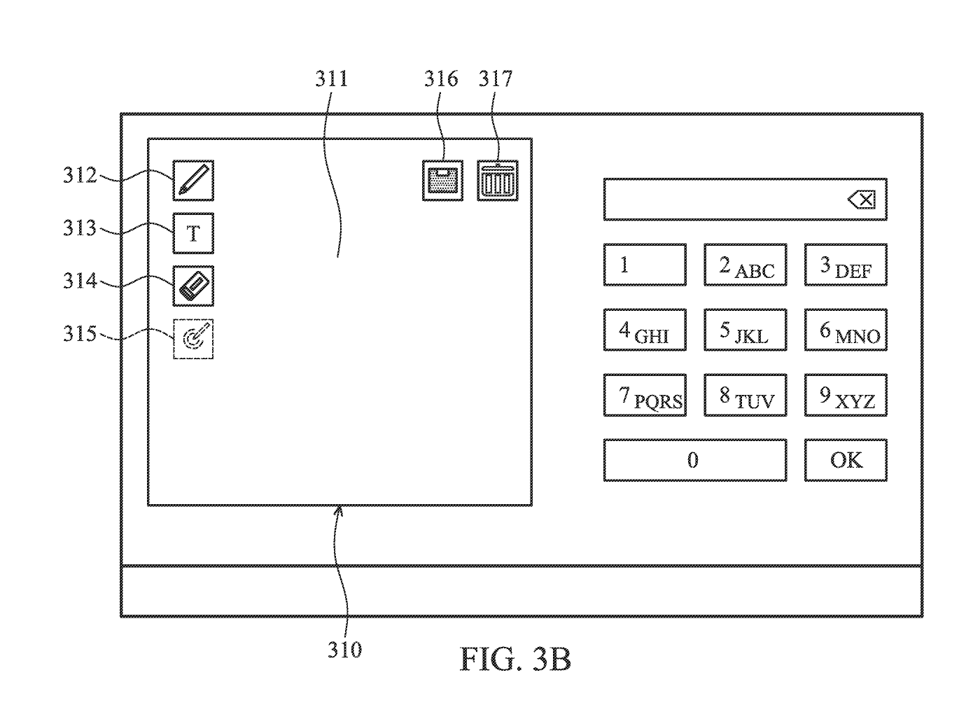

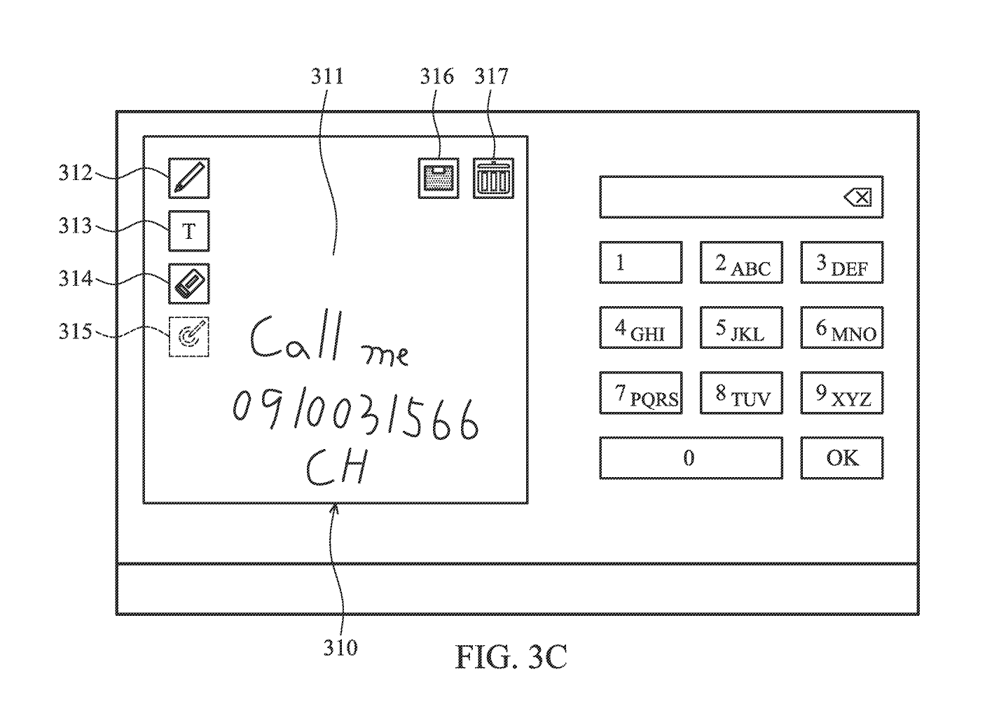

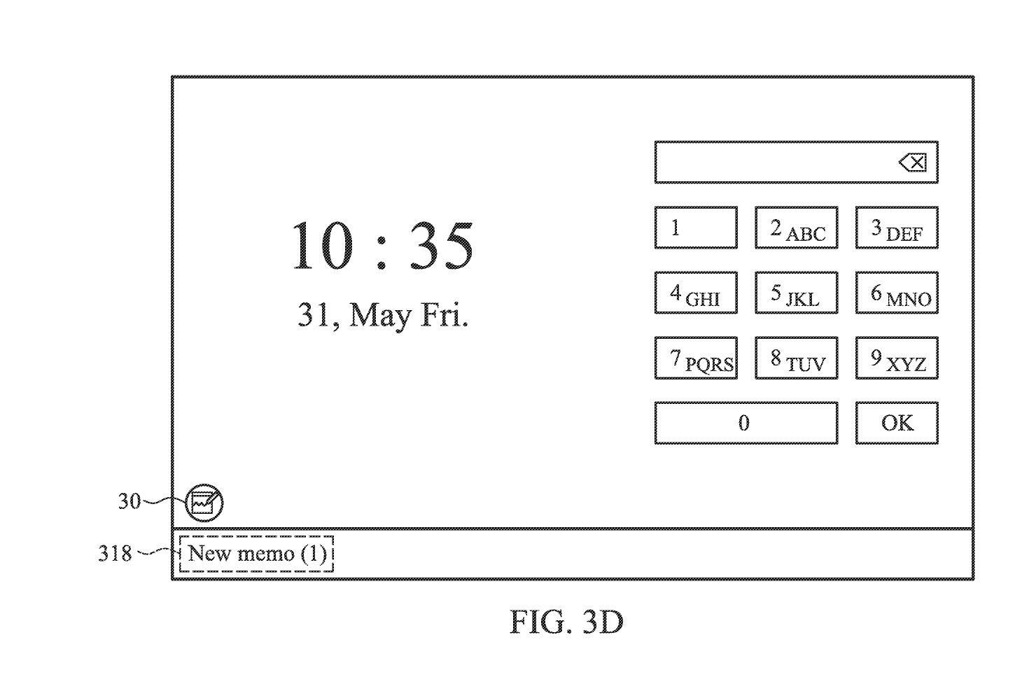

In addition, FIGS. 3A˜3D illustrate displays of an electronic device generated in the process illustrated in FIG. 2. The displays illustrated in FIGS. 3A˜3D are taken as examples, rather than limitations. It should be apparent that the invention is not limited to this example, and the virtual buttons, unlock icons and touch-gesture input area can be displayed in any design.

In step S201, the electronic device 10 is set to a user-interface lock state.

In step S203, when the electronic device is in the user-interface lock state, a detecting process is performed periodically for detecting a starting signal. The starting signal is generated in response to a pre-defined event, such as pulling out a stylus, activating a virtual button, and pressing a physical button. When a starting signal is detected, the method proceeds to step S205, otherwise the method returns to step S201.

According to this embodiment, the starting signal is generated in response to the activation of a virtual button. The virtual button can be provided on the touch screen. When the touch screen is turned on under the user-interface lock state, the display illustrated in FIG. 3A is presented. According to FIG. 3A, an electronic message board icon 30 is displayed on the lower left-hand corner of the screen display. When the electronic message board icon 30 is activated (touched), a corresponding starting signal is generated and detected. In addition, an unlock image or a keypad for inputting an unlock password is displayed on the right side of the screen display, and the time or date is displayed on the left side of the screen display.

In step S205, in response to detecting the starting signal, a touch-gesture recording process is executed. In step S207, a touch-gesture input area is displayed on the touch screen, thus the message maker can leave a message in the electronic device by inputting touch-gestures.

FIG. 3B illustrates an exemplary touch-gesture input area according to the embodiment. As shown in FIG. 3B, the touch-gesture input area 310 comprises an input zone 311, a pen-selecting button 312, a keyboard input button 313, an erasing button 314, a recognizing button 315, a storing button 316, and a canceling button 317. The touch-gesture input area 310 can be semi-transparent. Thus the time, date, and other images displayed under the touch-gesture input area 310 can be seen through the semi-transparent layer (i.e., the touch-gesture input area 310). It should be understood that the touch-gesture input area 310 can be opaque. In this case, the time, date, and other images displayed under the touch-gesture input area 310 cannot be seen when the touch-gesture input area 310 is presented. In this embodiment, the touch-gesture input area 310 is opaque, but the invention is not limited to this.

When a user (i.e., a message maker) is going to leave a message by handwriting input, he or she manipulates the pen-selecting button 312 to select one kind of brush stroke for the message writing, and writes down a message by touching and moving a fingertip or stylus on the touch-gesture input area 310. When a user (i.e., a message maker) is going to leave a message by a virtual keyboard, he or she can click the keyboard input button 313 to cause the electronic device to display a virtual keyboard on the touch screen, and then keys in a message directly using the virtual keyboard. The erasing button 314 is used for erasing a written word or a drawn line. The erasing button 314 can be implemented in a way similar to an “eraser function” in painting software. When the message maker has input the message and is going to store it, he or she can click the storing button 316 for storing the input touch-gesture as the message. When the user does not want to save the input message, he or she can click the canceling button 317, thus the display screen returns to FIG. 3A without storing the input touch-gesture.

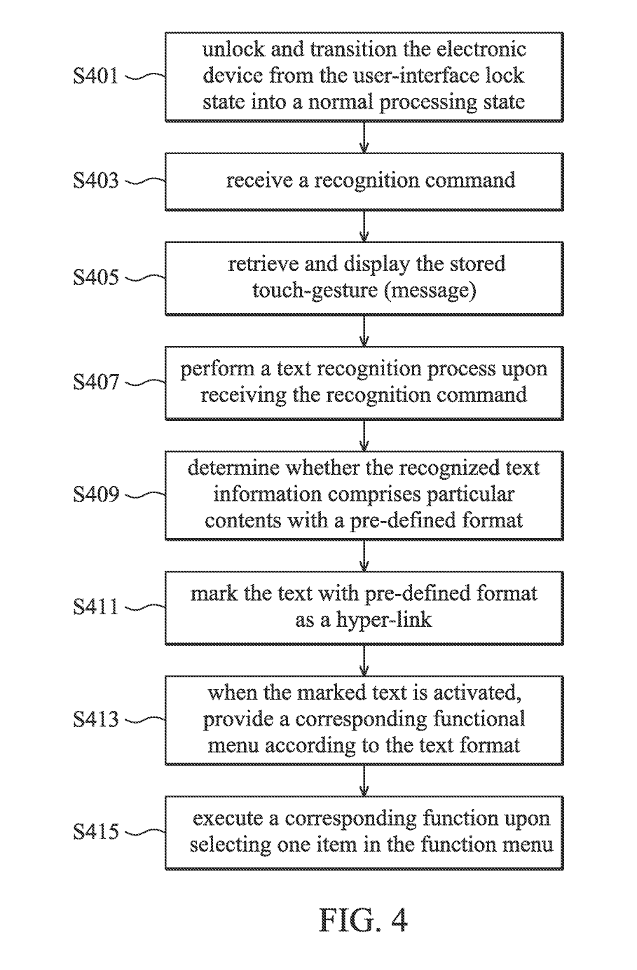

It should be noted that the recognizing button 315 is disabled under the user-interface lock state. For example, the recognizing button 315 is presented as a greyed out user interface element to indicate that the recognizing button 315 cannot currently be operated or selected by the user (i.e., the non-owner of the electronic device). Accordingly, the non-owner is allowed to leave a message by input touch-gestures in the electronic device, but is not allowed to perform recognition or other manipulation on the input touch-gestures. The recognizing button 315 is enabled after the electronic device is unlocked. Details of manipulating the recognizing button 315 are shown in FIG. 4 and the related description.

In step S209, a touch-gesture on the touch screen is received.

In this embodiment, a user (i.e., a message maker) leaves a message by handwriting input. The user selects a kind of brush stroke for the message writing by clicking the pen-selecting button 312. Then the user writes down a message by touching and moving a fingertip or stylus in the input zone 311 of the touch-gesture input area 310. Referring to FIG. 3C, the user has written down his name and telephone number, and has requested that the owner of the electronic device place a return call.

In step S210, the input text or touch-gesture is stored. For example, the user moves his fingertip on the touch screen to input touch-gestures and then clicks the storing button 316 to store the input touch-gesture as a message.

After the touch-gesture was stored in step S210, the touch screen stops displaying the touch-gesture. Instead, the touch screen displays a graphic symbol indicating the fact that the touch-gesture has been stored. Referring to FIG. 3D, the touch-gesture is not displayed on the touch screen, and an icon 318 is displayed at the lower left-hand corner of the touch screen in order to indicate the fact that a new touch-gesture has been stored. Meanwhile, the electronic message board icon 30 is displayed at the lower left-hand corner of the touch screen for someone to leave a new message. As described, when the electronic message board icon 30 is activated (touched), a corresponding starting signal is generated and step S205 through step S210 are executed accordingly. In addition to displaying the icon 318, other tools (such as a flashing light) can be used for indicating the presence of a new (unread) message.

FIG. 4 is a flowchart of an embodiment of a method of reading an electronic message stored in an electronic device. In the method illustrated in FIG. 4, the owner of the electronic device performs pre-defined processes (such as retrieving and recognizing) on the stored touch-gesture.

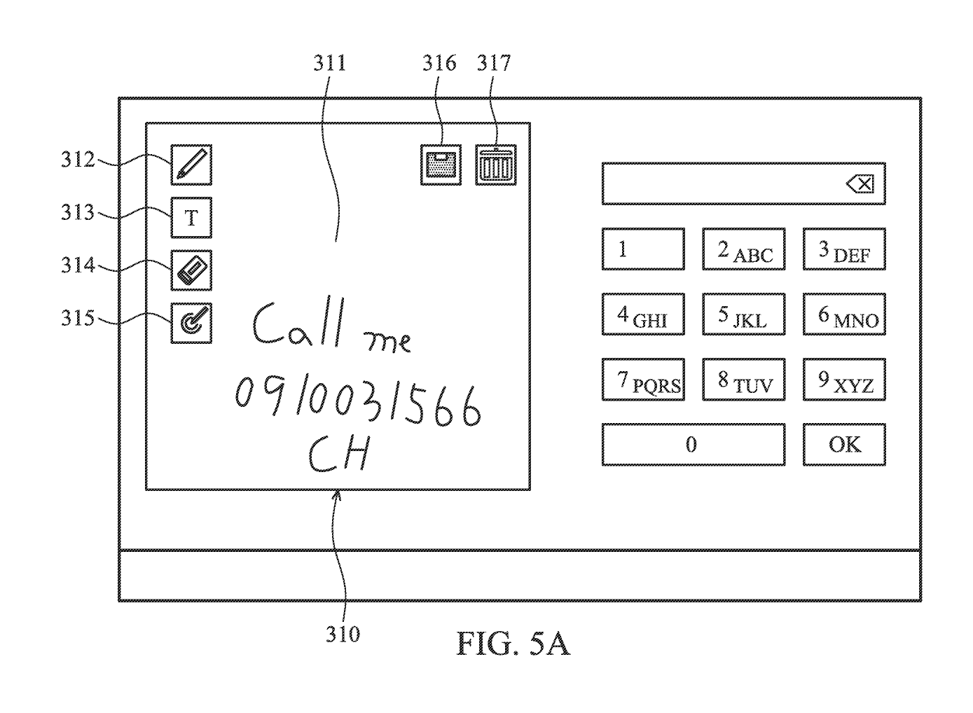

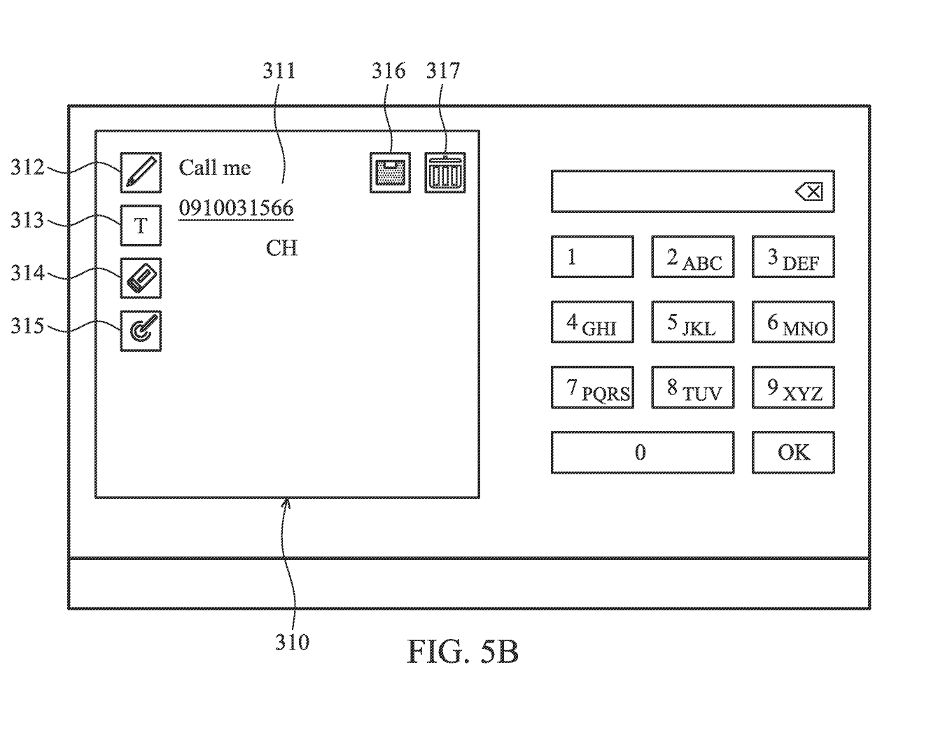

All of the steps illustrated in FIG. 2 are performed by a user other than the owner of the electronic device while the electronic device is in the user-interface lock state. Conversely, all of the steps illustrated in FIG. 4 are performed while the electronic device is unlocked. FIGS. 5A˜5B illustrate displays of an electronic device generated in the process illustrated in FIG. 4. The displays illustrated in FIGS. 5A˜5B are taken as examples, rather than limitations. It should be apparent that the invention is not limited to this example, and the virtual buttons, unlock icons and touch-gesture input area can be displayed in any design.

In step S401, the electronic device 10 is unlocked and is transitioned from the user-interface lock state into a normal processing state. Under the normal processing state, all functions equipped with the electronic device can be activated, and personal data, including the touch-gesture (message), stored in the electronic device is accessible.

In step S403, a recognition command is received.

In step S405, the stored touch-gesture (message) is retrieved and displayed. In this embodiment, the user has left a message by handwriting input. Before a recognition process is performed, the touch-gesture is displayed as it was input. As shown in FIG. 5A, an unprocessed touch-gesture is displayed on the touch screen. The display screen shown in FIG. 5A is almost the same as the one shown in FIG. 3C, except that the recognizing button 315 is enabled, i.e., not greyed out, in FIG. 5A. In other words, the recognizing button 315 is enabled and the corresponding recognition function is currently available after the electronic device is unlocked.

In step S407, a text recognition process is performed upon receiving the recognition command. Using the text recognition process, text information is obtained from the stored touch-gesture.

It should be noted that the text recognition process can be omitted when the user (non-owner) leaves the message by text input via a keyboard or keypad. In this case, step S407 is omitted and the method proceeds to step S409.

In step S409, it is determined whether the recognized text information comprises particular contents with a pre-defined format. The pre-defined format can be telephone number format, network address format, and electronic mail address format.

In step S411, text with pre-defined format is marked as a hyper-link. For example, in FIG. 5B, the touch-gesture has been recognized and the corresponding text has been marked as a selectable part.

In step S413, when the marked text is activated (for example, touched), a corresponding functional menu is provided according to the text format. For example, when the marked text representing a set of telephone number is activated, the provided function menu comprises the following items: placing a call to the telephone number, storing the telephone number in a contact list, and sending a message to the telephone number.

In step S415, a corresponding function is executed upon selecting one item in the function menu.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for controlling an electronic device with a touch-sensitive screen, comprising:
operating the electronic device in a user-interface lock state;
while the electronic device is in the user-interface lock state, detecting a starting signal, and in response to the starting signal, executing a touch-gesture recording process; and
receiving and storing a touch-gesture on the touch screen.

2. The method of claim 1, wherein the starting signal is generated in response to one of the following events: pulling out a stylus, activating a virtual button, and pressing a physical button.

3. The method of claim 1, the following steps are executed the touch-gesture recording process:
displaying an input area on the touch screen; and
receiving and storing the touch-gesture made in the input area.

4. The method of claim 1, wherein the touch screen stops displaying the touch-gesture after the touch-gesture was stored, and the touch screen displays a graphic symbol indicating the fact that the touch-gesture has been stored.

5. The method of claim 1, further comprising:
receiving a pre-defined unlock gesture, and transitioning the electronic device from the user-interface lock state into a normal processing state;
receiving a recognition command to cause the electronic device to recognize the touch-gesture to obtain text information therefrom;
determining whether the recognized text information comprises particular contents with pre-defined format;
initiating an action corresponding to the particular contents when the recognized text information comprises particular contents with pre-defined particular format.

6. An electronic device, comprising:
a touch-sensitive screen, displaying images and receiving touch inputs; and
a controller;
while the electronic device is in a user-interface lock state, the controller detects a starting signal, and in response to the starting signal, executes a touch-gesture recording process, and receives and stores a touch-gesture on the touch screen.

7. The electronic device of claim 6, wherein the starting signal is generated in response to one of the following events: pulling out a stylus, activating a virtual button, and pressing a physical button.

8. The electronic device of claim 6, further comprising a storage device, wherein the controller performs the following steps when executing the touch-gesture recording process:
controlling the touch screen to display an input area on the touch screen, and to receive and store the touch-gesture made in the input area.

9. The electronic device of claim 6, wherein the controller controls the touch screen to stop displaying the touch-gesture after the touch-gesture was stored, and to display a graphic symbol indicating the fact that the touch-gesture has been stored.

10. The electronic device of claim 6, wherein the controller further performs the steps of:
receiving a pre-defined unlock gesture, and transitioning the electronic device from the user-interface lock state into a normal processing state;
receiving a recognition command to cause the electronic device to recognize the touch-gesture to obtain text information therefrom;
determining whether the recognized text information comprises particular contents with pre-defined particular format;
initiating an action corresponding to the particular contents when the recognized text information comprises particular contents with pre-defined particular format.
